(19) United States
(12) Patent Application Publication
(10) Pub. No.: US 2018/0166234 A1
(43) Pub. Date: Jun. 14, 2018

(54) LUMINOUS KEYBOARD

(71) Applicant: PRIMAX ELECTRONICS LTD., Taipei (TW)

(72) Inventor: YI-CHEN WANG, Taipei (TW)

(21) Appl. No.: 15/459,304

(22) Filed: Mar. 15, 2017

(30) Foreign Application Priority Data
Dec. 9, 2016 (TW) 105140842

(51) Int. Cl. H01H 13/83; H01H 13/703; H01H 13/7065; H01H 13/86; G06F 3/02; F21V 11/00

(52) U.S. Cl. CPC H01H 13/83; H01H 13/703; F21V 11/00; H01H 13/86; G06F 3/0202; H01H 13/7065

(57) ABSTRACT

A luminous keyboard includes a membrane wiring board, a key structure and a light-emitting element. The membrane wiring board includes a membrane switch. The membrane switch is electrically conducted through the key structure. The key structure includes a keycap, a connecting element and a soft light-shading element. The connecting element is arranged between the membrane wiring board and the keycap. The keycap is movable upwardly or downwardly relative to the membrane wiring board through the connecting element. The soft light-shading element is connected with the keycap and arranged around the connecting element. The at least one light-emitting element provides plural light beams. After first portions of the plural light beams are transmitted through the membrane wiring board, at least portions of the plural light beams are outputted from at least one light-transmissible region of the keycap. Consequently, the light utilization efficiency is enhanced.

### FIELD OF THE INVENTION

The present invention relates to a luminous keyboard, and more particularly to a luminous keyboard with an illuminating function.

### BACKGROUND OF THE INVENTION

Recently, with the increasing development of information industries, portable information devices such as notebook computers, mobile phones or personal digital assistants are possibly used in various environments. In case that a portable information device is used in a dim environment, the numbers and the characters marked on the keys of the keyboard of the portable information device are not clearly visible. In other words, the dim environment becomes hindrance from operating the keyboard. In addition, if the numbers and the characters marked on the keys of the keyboard are reluctantly viewed in the dim environment, the user is readily suffered from vision impairment. For solving these drawbacks, a luminous keyboard has been disclosed. The luminous keyboard can be used in the dim environment in order to increase the applications thereof. Moreover, by changing the arrangement of luminous regions, the information device having the luminous keyboard is more aesthetically-pleasing and thus the marketing competitiveness thereof is enhanced.

Please refer to FIGS. 1, 2, 3 and 4. FIG. 1 is a schematic side view illustrating a conventional luminous keyboard. FIG. 2 is a schematic exploded view illustrating a membrane wiring board of the conventional luminous keyboard of FIG. 1. FIG. 3 schematically illustrates the optical path within the light guide plate of the luminous keyboard of FIG. 1. FIG. 4 is a schematic exploded view illustrating the relationship between a keycap and key frame of a key structure of the luminous keyboard of FIG. 1. The conventional luminous keyboard 1 comprises a reflecting plate 11, a light guide plate 12, a metallic base plate 13, a membrane wiring board 14, plural key structures 15, plural light-emitting elements 16 and a key frame 17. The membrane wiring board 14 comprises a lower wiring plate 141, an upper wiring plate 142 and an intermediate plate 143. The intermediate plate 143 is arranged between the lower wiring plate 141 and the upper wiring plate 142. All of the lower wiring board 141, the intermediate board 143 and the upper wiring board 142 are made of a transparent light-guiding material.

The lower wiring plate 141 comprises a first circuit pattern 1411. The first circuit pattern 1411 comprises plural silver paste conductor lines 14111 and plural lower contacts 14112. The upper wiring plate 142 comprises a second circuit pattern 1421. The second circuit pattern 1421 comprises plural silver paste conductor lines 14211 and plural upper contacts 14212. The intermediate plate 143 comprises plural perforations 1431 corresponding to the plural lower contacts 14112 and the plural upper contacts 14212, respectively. Each of the upper contacts 14212 and the corresponding lower contact 14112 are collectively defined as a membrane switch 144.

The metallic base plate 13 is disposed under the membrane wiring board 14 for connecting the plural key structures 15. In addition, the metallic base plate 13 comprises plural base plate openings 131 corresponding to the plural key structures 15. Each of the key structures 15 is disposed over a corresponding membrane switch 144. As the keycap 151 of any key structure 15 is depressed and moved downwardly, the corresponding membrane switch 144 is pushed by the key structure 15, and thus the corresponding membrane switch 144 is electrically conducted. Under this circumstance, the luminous keyboard 1 generates a corresponding key signal. The key frame 17 has plural receiving holes 171 corresponding to the plural key structures 15. The keycap 151 of each key structure 15 is movably disposed within the corresponding receiving hole 171 of the key frame 17.

The light-emitting elements 16 are located at bilateral sides of the light guide plate 12 or embedded within the light guide plate 12. The light-emitting elements 16 emit light beams to the light guide plate 12. The light guide plate 12 is disposed on the reflecting plate 11. Moreover, plural light-guiding dots 121 are formed on a surface of the light guide plate 12 for collecting and scattering the light beams. The light-guiding dots 121 are aligned with corresponding key structures 15. After the light beams are introduced into the light guide plate 12, the light beams are diffused into the whole light guide plate 12. Moreover, portions L11 of the light beams are projected onto the light-guiding dots 121. Due to the material properties of the light-guiding dots 121, the portions L11 of the light beams are scattered upwardly and downwardly. The upwardly-scattered portions L111 of the light beams that are scattered are sequentially transmitted through the plural base plate openings 131 of the metallic base plate 13 and the membrane wiring board 14 and then projected to the plural key structures 15. Consequently, portions L111a of the upwardly-scattered light beams L111 of the light beams are outputted from plural light-transmissible regions 1511 (e.g., character regions or numeric regions) of the keycap 151 to produce the illuminating efficacy. The downwardly-scattered light beams L112 are reflected upwardly by the reflecting plate 11. Consequently, the light beams provided by the light-emitting elements 16 can be well utilized.

However, the conventional luminous keyboard 1 still has the following drawbacks. For example, there is a vacant space between the keycaps 151 of every two adjacent key structures 15 and another vacant space between the keycap 151 of any key structure 15 and the key frame 17. In the upwardly-scattered light beams L111, only the portions L111a of the light beams are outputted from the plural light-transmissible regions 1511 (e.g., character regions or numeric regions) of the keycap 151, other portions L111b of the upwardly-scattered portions L111 of the light beams are leaked out from the vacant space between the keycaps 151 of every two adjacent key structures 15 or the vacant space between any keycap 151 and the key frame 17. Under this circumstance, the plural light-transmissible regions 1511 (e.g., character regions or numeric regions) of the keycap 151 have insufficient luminous uniformity or insufficient brightness.

Since the light utilization efficiency of the conventional luminous keyboard is unsatisfied, the conventional luminous keyboard needs to be further improved.

### SUMMARY OF THE INVENTION

The present invention relates to a luminous keyboard. The light beams are not leaked out from the vacant space between the keycaps of every two adjacent key structures and the vacant space between any keycap and the key frame. Consequently, the luminous keyboard has enhanced light utilization efficiency.

In accordance with an aspect of the present invention, there is provided a luminous keyboard. The luminous keyboard includes a membrane wiring board, a key structure and at least one light-emitting element. The membrane wiring board includes a membrane switch. The key structure corresponds to the membrane switch. The membrane switch is electrically conducted through the key structure. The key structure includes a keycap, a connecting element and a soft light-shading element. The keycap has at least one light-transmissible region. The connecting element is arranged between the membrane wiring board and the keycap. The keycap is movable upwardly or downwardly relative to the membrane wiring board through the connecting element. The soft light-shading element is connected with the keycap and arranged around the connecting element. The at least one light-emitting element provides plural light beams. After first portions of the plural light beams are transmitted through the membrane wiring board, the first portions of the plural light beams are outputted from the at least one light-transmissible region of the keycap. After second portions of the plural light beams are transmitted through the membrane wiring board, the second portions of the plural light beams are projected on the soft light-shading element and reflected by the soft light-shading element, so that the second portions of the plural light beams are outputted from the at least one light-transmissible region of the keycap.

In accordance with another aspect of the present invention, there is provided a luminous keyboard. The luminous keyboard includes a membrane wiring board, at least one light-emitting element, plural key structures and a key frame. The membrane wiring board includes plural membrane switches. The at least one light-emitting element provides plural light beams. The plural key structures correspond to the plural membrane switches. The membrane switches are electrically conducted through the corresponding key structures. One of the plural key structures comprises a keycap, a connecting element and a soft light-shading element. The connecting element is arranged between the membrane wiring board and the keycap. The keycap is movable upwardly or downwardly relative to the membrane wiring board through the connecting element. The soft light-shading element is connected with the keycap and protruded downwardly from the keycap. The key frame includes plural receiving holes corresponding to the plural key structures. The keycap is movably disposed within the corresponding receiving hole. At least portions of the plural light beams are blocked by the soft light-shading element, and are not leaked out from a vacant space between the keycap and an adjacent keycap and a vacant space between the keycap and the key frame.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a conventional luminous keyboard;

FIG. 2 is a schematic exploded view illustrating a membrane wiring board of the conventional luminous keyboard of FIG. 1;

FIG. 3 schematically illustrates the optical path within the luminous keyboard of FIG. 1;

FIG. 4 is a schematic exploded view illustrating the relationship between a keycap and key frame of a key structure of the luminous keyboard of FIG. 1;

FIG. 5 is a schematic side view illustrating a luminous keyboard according to a first embodiment of the present invention;

FIG. 6 is a schematic exploded view illustrating a membrane wiring board of the luminous keyboard of FIG. 5;

FIG. 7 schematically illustrates the optical path within a backlight module of the luminous keyboard of FIG. 5;

FIG. 8 is a schematic exploded view illustrating the relationship between a keycap and key frame of a key structure of the luminous keyboard of FIG. 5;

FIG. 9 is a schematic side view illustrating a luminous keyboard according to a second embodiment of the present invention;

FIG. 10 is a schematic side view illustrating a key structure and a membrane wiring board of a luminous keyboard according to a third embodiment of the present invention;

FIG. 11 is a schematic side view illustrating a key structure and a membrane wiring board of a luminous keyboard according to a fourth embodiment of the present invention; and

FIG. 12 is a schematic side view illustrating a key structure and a membrane wiring board of a luminous keyboard according to a fifth embodiment of the present invention.

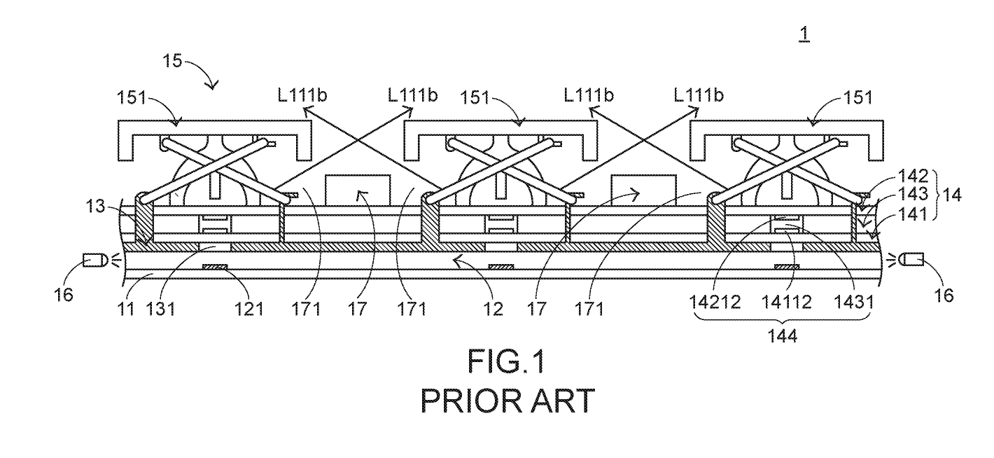

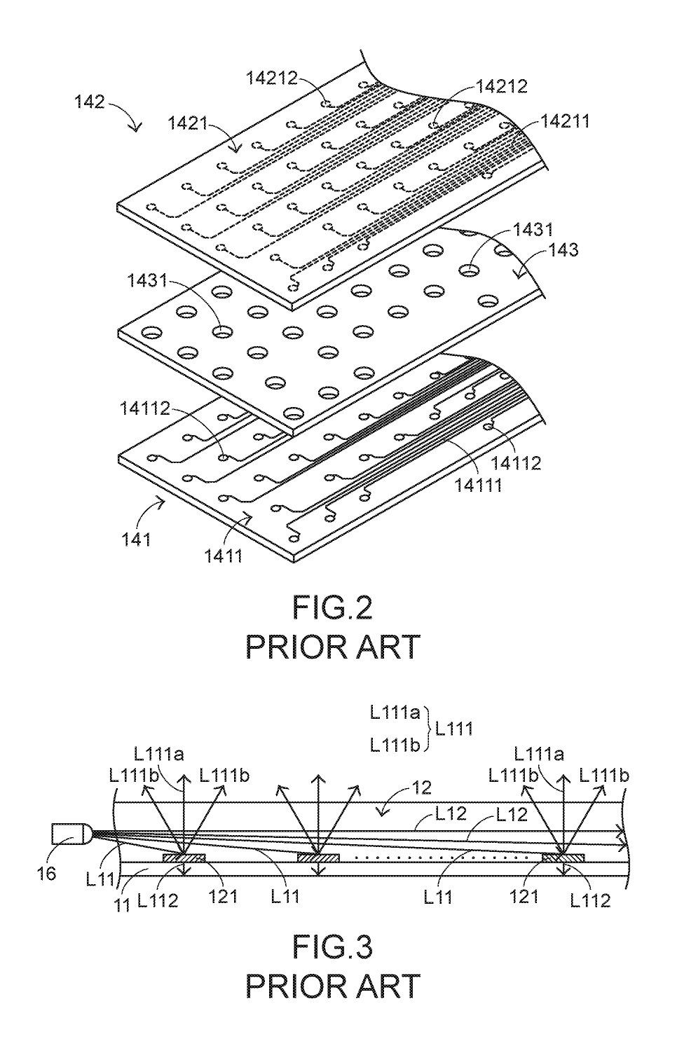

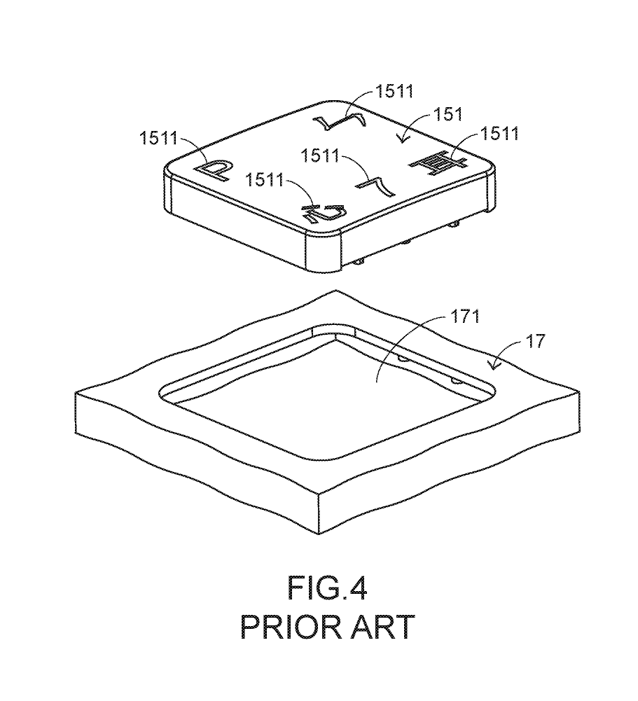

### DETAILED DESCRIPTION OF THE PREFERRED EMBODIMENT

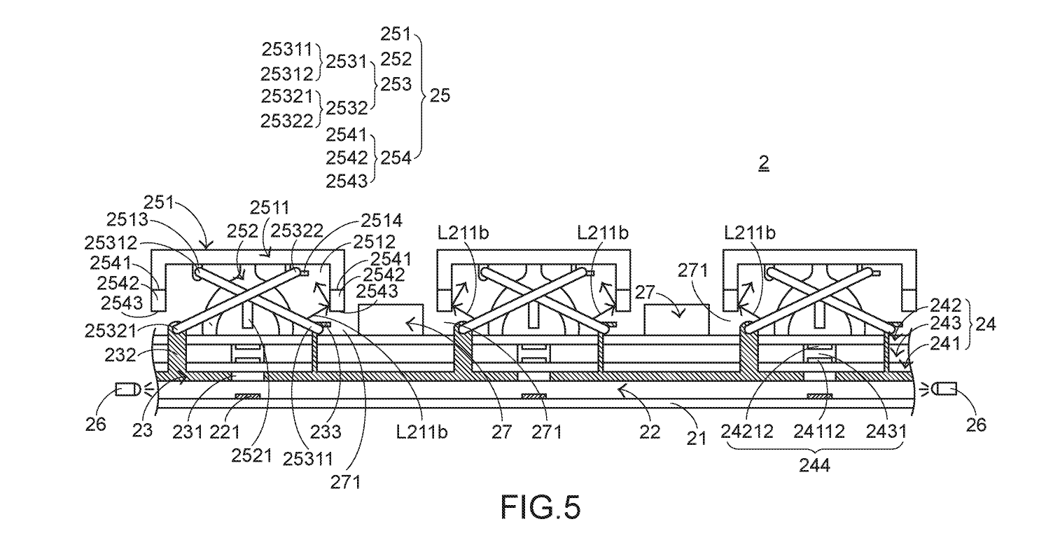

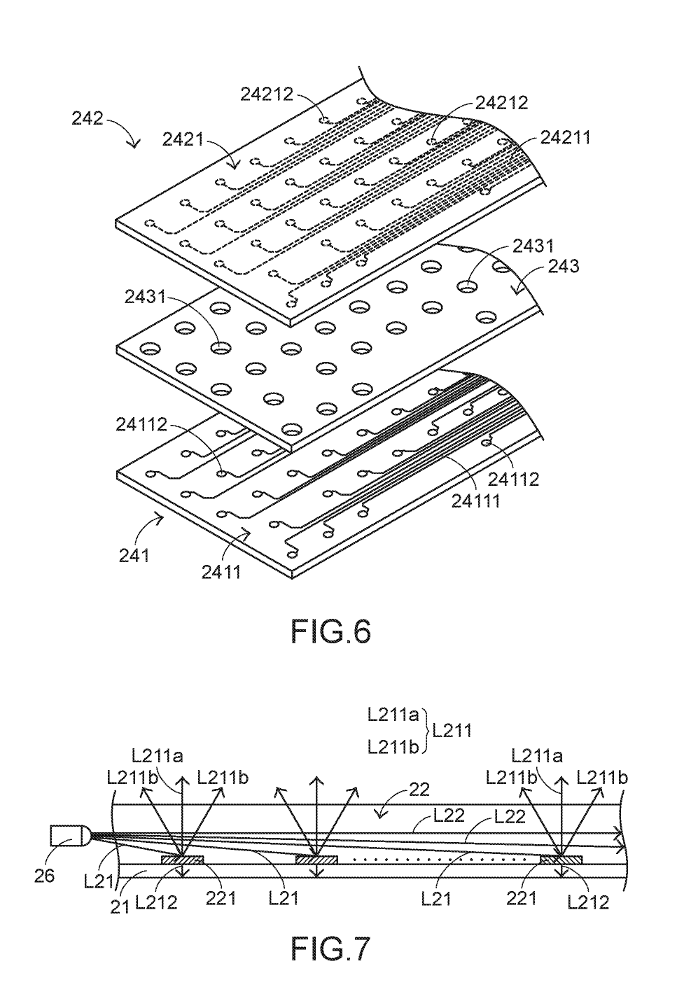

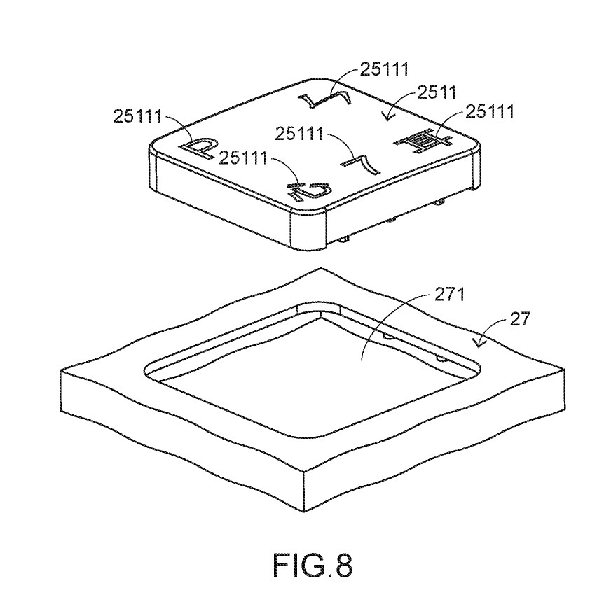

Please refer to FIGS. 5, 6, 7 and 8. FIG. 5 is a schematic side view illustrating a luminous keyboard according to a first embodiment of the present invention. FIG. 6 is a schematic exploded view illustrating a membrane wiring board of the luminous keyboard of FIG. 5. FIG. 7 schematically illustrates the optical path within a backlight module of the luminous keyboard of FIG. 5. FIG. 8 is a schematic exploded view illustrating the relationship between a keycap and key frame of a key structure of the luminous keyboard of FIG. 5.

From bottom to top, a backlight module 28, a metallic base plate 23, a membrane wiring board 24 and plural key structures 25 of the luminous keyboard 2 are sequentially shown. The luminous keyboard 2 further comprises a key frame 27 and plural light-emitting elements 26. The light-emitting elements 26 are located at bilateral sides of the backlight module 28 or embedded within the backlight module 28. Preferably but not exclusively, the light-emitting elements 26 are light emitting diodes.

The membrane wiring board 24 comprises a lower wiring plate 241 and an upper wiring plate 242. A first circuit pattern 2411 is formed on a top surface of the lower wiring plate 241. The first circuit pattern 2411 comprises plural silver paste conductor lines 24111 and plural lower contacts 24112. A second circuit pattern 2421 is formed on a bottom surface of the upper wiring plate 242. The second circuit pattern 2421 comprises plural silver paste conductor lines 24211 and plural upper contacts 24212. The plural upper contacts 24212 are aligned with the plural lower contacts 24112, respectively. Each of the upper contacts 24212 and the corresponding lower contact 24112 are separated from each other by a spacing distance. Moreover, each of the upper contacts 24212 and the corresponding lower contact 24112 are collectively defined as a membrane switch 244. For allowing each of the upper contacts 24212 and the corresponding lower contact 24112 to be separated from each other by the spacing distance, the membrane wiring board 24 further comprises an intermediate plate 243. The intermediate plate 243 is arranged between the lower wiring plate 241 and the upper wiring plate 242. The intermediate plate 243 comprises plural perforations 2431 corresponding to the plural lower contacts 24112 and the plural upper contacts 24212, respectively.

The metallic base plate 23 is used for connecting the plural key structures 25. In addition, the metallic base plate 23 comprises plural base plate openings 231 corresponding to the plural key structures 25. The plural key structures 25 are aligned with corresponding membrane switches 244. Each key structure 25 comprises a keycap 251, a connecting element 253 and soft light-shading element 254. The keycap 251 comprises a casing 2511 and a recess part 2512. The recess part 2512 is formed within the casing 2511. Moreover, plural light-transmissible regions 25111 (i.e., character regions or numeric regions) are formed on the casing 2511. The connecting element 253 is arranged between the membrane wiring board 24 and the keycap 251 and connected with the metallic base plate 23 and the corresponding keycap 251. Consequently, the keycap 251 is movable upwardly or downwardly relative to the membrane wiring board 24. The key frame 27 has plural receiving holes 271 corresponding to the plural key structures 25. The keycap 251 of each key structure 25 is movably disposed within the corresponding receiving hole 271 of the key frame 27.

In this embodiment, each soft light-shading element 254 is arranged around the corresponding connecting element 253. A top surface 2541 of each soft light-shading element 254 is connected with the periphery of the casing 2511 of the corresponding keycap 251. A wall part 2542 of each soft light-shading element 254 is protruded downwardly from the periphery of the casing 2511 of the corresponding keycap 251. Although the wall part 2542 of the soft light-shading element 254 is protruded downwardly, a bottom surface 2543 of the soft light-shading element 254 is not contacted with the membrane wiring board 24 when the corresponding keycap 251 is not moved downwardly relative to the membrane wiring board 24. Preferably but not exclusively, each soft light-shading element 254 is made of a rubbery material. Moreover, the soft light-shading element 254 and the corresponding keycap 251 are combined together through an adhering process or a double-injection molding process.

In this embodiment, the connecting element 253 is a scissors-type connecting element. Moreover, the scissors-type connecting element 253 comprises a first frame 2531 and a second frame 2532. The metallic base plate 23 further comprises a first fixing structure 232 and a second fixing structure 233. Each of the plural key structures 25 further comprises an elastic element 252. The elastic element 252 is arranged between the corresponding keycap 251 and the membrane wiring board 24. The elastic element 252 further comprises a sustaining part 2521. The keycap 251 of each key structure 25 comprises a first keycap connecting structure 2513 and a second keycap connecting structure 2514.

A first end 25311 of the first frame 2531 is connected to the second fixing structure 233, and a second end 25312 of the first frame 2531 is connected to the first keycap connecting structure 2513. In addition, a first end 25321 of the second frame 2532 is connected to the first fixing structure 232, and a second end 25322 of the second frame 2532 is connected to the second keycap connecting structure 2514. It is noted that the connection relationships between the connecting element 253, the metallic base plate 23 and the keycap 251 are presented herein for purpose of illustration and description only.

Moreover, as the keycap 251 of any key structure 25 is depressed and moved downwardly relative to the membrane wiring board 24, the first frame 2531 and the second frame 2532 of the corresponding connecting element 253 are switched from an open-scissors state to a folded state. Moreover, in response to the downward movement of the keycap 251, the corresponding elastic element 252 is compressed by the keycap 251, and the corresponding upper contact 24212 is pushed by the sustaining part 2521 of the elastic element 252. Consequently, the corresponding upper contact 24212 is contacted with the corresponding lower contact 24112 through the corresponding perforation 2431, and the corresponding membrane switch 244 is electrically conducted. Under this circumstance, the membrane wiring board 24 generates a corresponding key signal. Moreover, when the depressing force exerted on the keycap 251 of the key structure 25 is eliminated, the keycap 251 is moved upwardly relative to the membrane wiring board 24 in response to the elastic force of the elastic element 252. Under this circumstance, the first frame 2531 and the second frame 2532 are switched from the folded state to the open-scissors state, and the keycap 251 is returned to its original position.

The backlight module 28 comprises a reflecting plate 21 and a light guide plate 22. The light guide plate 22 is disposed on the reflecting plate 21. Moreover, plural light-guiding dots 221 are formed on a surface of the light guide plate 22 for collecting and scattering the light beams. The light-guiding dots 221 are aligned with corresponding key structures 25. After the light beams from the light-emitting element 26 are introduced into the light guide plate 22, the light beams are diffused into the whole light guide plate 22. Moreover, portions L21 of the light beams are projected onto the light-guiding dots 221. Due to the material properties of the light-guiding dots 221, the portions L21 of the light beams are scattered upwardly and downwardly. The upwardly-scattered portions L211 of the light beams that are scattered are sequentially transmitted through the plural base plate openings 231 of the metallic base plate 23 and the membrane wiring board 24 and then projected to the plural key structures 25. As a consequence, first portions L211a of the upwardly-scattered light beams L211 are outputted from plural light-transmissible regions 25111 (i.e., character regions or numeric regions) of the keycap 251 to produce the illuminating efficacy. The downwardly-scattered light beams L212 are reflected upwardly by the reflecting plate 21. Consequently, the light beam provided by the light-emitting elements 26 can be well utilized. Moreover, second portions L211b of the light beams L211 that are upwardly scattered by the light-guiding dots 221 are blocked by the soft light-shading element 254 of the key structure 25. Consequently, the second portions L211b of the light beams L211 are not leaked out from the vacant space between the keycaps 251 of every two adjacent key structures 25 and the vacant space between any keycap 251 and the key frame 27. Especially, the second portions L211b of the light beams L211 are projected to the soft light-shading element 254 and reflected by the soft light-shading element 254. Consequently, the optical paths of the second portions L211b of the light beams L211 are confined in the space between the keycap 251 and the soft light-shading element 254. Then, the second portions L211b of the light beams L211 are outputted from the plural light-transmissible regions 25111 (i.e., character regions or numeric regions) of the casing 2511 of the keycap 251. Since the light beams are not leaked out from the vacant space between the keycaps 251 of every two adjacent key structures 25 and the vacant space between any keycap 251 and the key frame 27, the plural light-transmissible regions 2511 (e.g., character regions or numeric regions) of the keycap 251 have enhanced luminous uniformity and enhanced brightness.

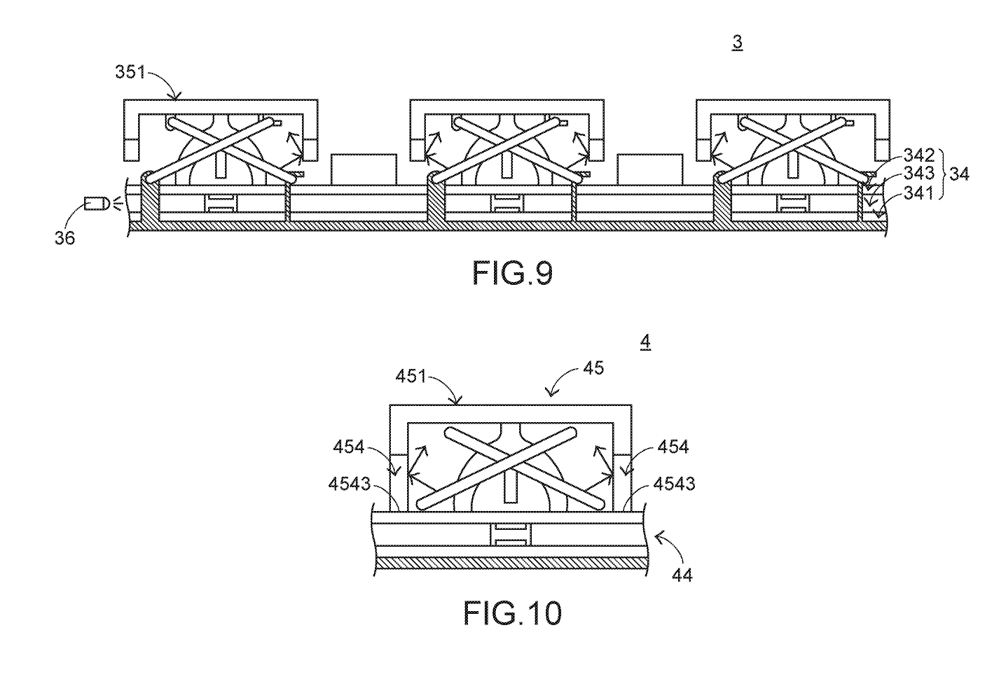

FIG. 9 is a schematic side view illustrating a luminous keyboard according to a second embodiment of the present invention. Except that the luminous keyboard 3 is not equipped with the backlight module, the other components of the luminous keyboard 3 are similar to those of the luminous keyboard of the first embodiment, and are not redundantly described herein. In the luminous keyboard 3 of this embodiment, the lower wiring plate 341, the upper wiring plate 342 and/or the intermediate plate 343 of the membrane wiring board 34 is made of a light-guiding material such as polycarbonate (PC) or polymethylmethacrylate (PMMA). Moreover, plural light-guiding dots (not shown) are formed on the lower wiring plate 341, the upper wiring plate 342 and/or the intermediate plate 343. The membrane wiring board 34 has the light-guiding function. When the light beams provided by the light-emitting elements 36 are introduced into the membrane wiring board 34, the light beams can be diffused within the membrane wiring board 34. Due to the material properties of the light-guiding dots, portions of the light beams (not shown) are scattered upwardly. Consequently, the light beams are outputted from the keycap 351.

FIG. 10 is a schematic side view illustrating a key structure and a membrane wiring board of a luminous keyboard according to a third embodiment of the present invention. For succinctness, only some components of the key structure 45 and the membrane wiring board 44 are shown in FIG. 10. In this embodiment, a bottom surface 4543 of the soft light-shading element 454 is contacted with the membrane wiring board 44 when the corresponding keycap 451 is not moved downwardly relative to the membrane wiring board 44. The other components of the luminous keyboard 4 are similar to those of the luminous keyboards of the first embodiment and the second embodiment, and are not redundantly described herein.

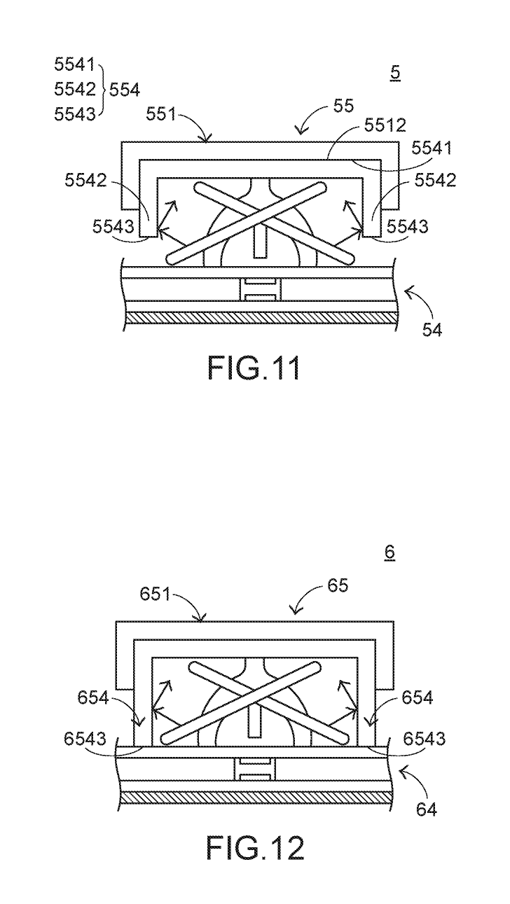

FIG. 11 is a schematic side view illustrating a key structure and a membrane wiring board of a luminous keyboard according to a fourth embodiment of the present invention. For succinctness, only some components of the key structure 55 and the membrane wiring board 54 are shown in FIG. 11. In this embodiment, a top surface 5541 of the soft light-shading element 554 is connected with a top surface of the recess part 5512 of the keycap 551. A wall part 5542 of each soft light-shading element 554 is protruded toward the outer side of the recess part 5512 of the corresponding keycap 551. Although the wall part 5542 of the soft light-shading element 554 is protruded downwardly, a bottom surface 5543 of the soft light-shading element 554 is not contacted with the membrane wiring board 54 when the corresponding keycap 551 is not moved downwardly relative to the membrane wiring board 54. The other components of the luminous keyboard 5 are similar to those of the luminous keyboards of the first embodiment and the second embodiment, and are not redundantly described herein.

FIG. 12 is a schematic side view illustrating a key structure and a membrane wiring board of a luminous keyboard according to a fifth embodiment of the present invention. For succinctness, only some components of the key structure 65 and the membrane wiring board 64 are shown in FIG. 12. In this embodiment, a bottom surface 6543 of the soft light-shading element 654 is contacted with the membrane wiring board 64 when the corresponding keycap 651 is not moved downwardly relative to the membrane wiring board 64. The other components of the luminous keyboard 6 are similar to those of the luminous keyboards of the fourth embodiment, and are not redundantly described herein.

The luminous keyboards of the second, third, fourth and fifth embodiments are the variant examples of the luminous keyboard of the first embodiment. Moreover, the second portions of the light beams that are upwardly scattered by the light-guiding dots are blocked by the soft light-shading element of the key structure. Consequently, the second portions of the light beams are not leaked out from the vacant space between the keycaps of every two adjacent key structures and the vacant space between any keycap and the key frame. Especially, the second portions of the light beams are projected to the soft light-shading element and reflected by the soft light-shading element. Consequently, the optical paths of the second portions of the light beams are confined in the space between the keycap and the soft light-shading element. Then, the second portions of the light beams are outputted from the plural light-transmissible regions (i.e., character regions or numeric regions) of the casing of the keycap.

The luminous keyboards of the second, third, fourth and fifth embodiments also have the benefits similar to the luminous keyboard of the first embodiment. Since the light beams are not leaked out from the vacant space between the keycaps of every two adjacent key structures and the vacant space between any keycap and the key frame, the plural light-transmissible regions (e.g., character regions or numeric regions) of the keycap have enhanced luminous uniformity and enhanced brightness. The examples of the above luminous keyboards are presented herein for purpose of illustration and description only.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A luminous keyboard, comprising:
a membrane wiring board comprising a membrane switch;
a key structure corresponding to the membrane switch, wherein the membrane switch is electrically conducted through the key structure, and the key structure comprises a keycap, a connecting element and a flexible light-shading element, wherein the keycap has at least one light-transmissible region, the connecting element is arranged between the membrane wiring board and the keycap, the keycap is movable upwardly or downwardly relative to the membrane wiring board through the connecting element, and the flexible light-shading element is connected with the keycap and arranged around the connecting element, and when the keycap is not moved downwardly relative to the membrane wiring board, a bottom surface of the flexible light-shading element is contacted with the membrane wiring board; and
at least one light-emitting element providing plural light beams, wherein after first portions of the plural light beams are transmitted through the membrane wiring board, the first portions of the plural light beams are outputted from the at least one light-transmissible region of the keycap, wherein after second portions of the plural light beams are transmitted through the membrane wiring board, the second portions of the plural light beams are projected on the flexible light-shading element and reflected by the flexible light-shading element, so that the second portions of the plural light beams are outputted from the at least one light-transmissible region of the keycap.

2. The luminous keyboard according to claim 1, wherein the keycap comprises a casing and a recess part within the casing, wherein a top surface of the flexible light-shading element is connected with a top surface of the recess part and protruded toward an outer side of the recess part of the keycap, or the top surface of the flexible light-shading element is connected with a periphery of the casing of the keycap.

3. (canceled)

4. (canceled)

5. The luminous keyboard according to claim 1, wherein the flexible light-shading element is made of a rubbery material.

6. The luminous keyboard according to claim 1, wherein the flexible light-shading element and the keycap are combined together through an adhering process or a double-injection molding process.

7. The luminous keyboard according to claim 1, wherein the membrane wiring board comprises:
a lower wiring plate having a first circuit pattern, wherein the first circuit pattern comprises a lower contact; and
an upper wiring plate having a second circuit pattern, wherein the second circuit pattern comprises an upper contact corresponding to the lower contact, wherein the upper contact and the lower contact are separated from each other by a spacing distance, and the upper contact and the lower contact are collaboratively defined as the membrane switch.

8. The luminous keyboard according to claim 7, wherein the membrane wiring board further comprises an intermediate plate, wherein the intermediate plate is arranged between the upper wiring plate and the lower wiring plate, so that the upper contact and the lower contact are separated from each other by the spacing distance, wherein the intermediate plate comprises a perforation corresponding to the lower contact and the upper contact.

9. The luminous keyboard according to claim 7, wherein the at least one light-emitting element provides the plural light beams to the membrane wiring board, and at least a part of the membrane wiring board is made of a light-guiding material.

10. The luminous keyboard according to claim 1, further comprising a backlight module, wherein the backlight module is disposed under the membrane wiring board, and the at least one light-emitting element provides the plural light beams to the backlight module.

11. A luminous keyboard, comprising:
a membrane wiring board comprising plural membrane switches;
at least one light-emitting element providing plural light beams;
plural key structures corresponding to the plural membrane switches, wherein the membrane switches are electrically conducted through the corresponding key structures, and one of the plural key structures comprises a keycap, a connecting element and a flexible light-shading element, wherein the connecting element is arranged between the membrane wiring board and the keycap, the keycap is movable upwardly or downwardly relative to the membrane wiring board through the connecting element, and the flexible light-shading element is connected with the keycap and protruded downwardly from the keycap, and when the keycap is not moved downwardly relative to the membrane wiring board, a bottom surface of the corresponding soft light-shading element is contacted with the membrane wiring board;
a key frame comprising plural receiving holes corresponding to the plural key structures, wherein the keycap is movably disposed within the corresponding receiving hole,
wherein at least portions of the plural light beams are blocked by the flexible light-shading element, and are not leaked out from a vacant space between the keycap and an adjacent keycap and a vacant space between the keycap and the key frame.

12. The luminous keyboard according to claim 11, wherein the keycap comprises a casing and a recess part within the casing, wherein a top surface of the flexible light-shading element is connected with a top surface of the recess part and protruded toward an outer side of the recess part of the keycap, or the top surface of the flexible light-shading element is connected with a periphery of the casing of the keycap.

13. (canceled)

14. (canceled)

15. The luminous keyboard according to claim 11, wherein the flexible light-shading element is made of a rubbery material.

16. The luminous keyboard according to claim 11, wherein the flexible light-shading element and the corresponding keycap are combined together through an adhering process or a double-injection molding process.

17. The luminous keyboard according to claim 11, wherein the membrane wiring board comprises:
a lower wiring plate having a first circuit pattern, wherein the first circuit pattern comprises plural lower contacts; and
an upper wiring plate having a second circuit pattern, wherein the second circuit pattern comprises plural upper contacts corresponding to the plural lower contacts, wherein each of the upper contacts and the corresponding lower contact are separated from each other by a spacing distance, and each of the upper contacts and the corresponding lower contact are collaboratively defined as the corresponding membrane switch.

18. The luminous keyboard according to claim 17, wherein the membrane wiring board further comprises an intermediate plate, wherein the intermediate plate is arranged between the upper wiring plate and the lower wiring plate, so that each of the upper contacts and the corresponding lower contact are separated from each other by the spacing distance, wherein the intermediate plate comprises plural perforations corresponding to the plural lower contacts and the plural upper contacts.

19. The luminous keyboard according to claim 17, wherein the at least one light-emitting element provides the plural light beams to the membrane wiring board, and at least a part of the membrane wiring board is made of a light-guiding material.

20. The luminous keyboard according to claim 11, further comprising a backlight module, wherein the backlight module is disposed under the membrane wiring board, and the at least one light-emitting element provides the plural light beams to the backlight module.
